(19) United States
(12) Patent Application Publication
(10) Pub. No.: US 2003/0050000 A1
(43) Pub. Date: Mar. 13, 2003

(54) Super-abrasive grinding wheel

(75) Inventors: Takeshi Nonogawa, Toki-shi (JP); Kensei Shimura, Haguri-gun (JP)

Correspondence Address: OLIFF & BERRIDGE, PLC, P.O. BOX 19928, ALEXANDRIA, VA, 22320, US

(73) Assignee: NORITAKE CO., LIMITED, Nagoya-shi (JP)

(21) Appl. No.: 10/230,347

(22) Filed: Aug. 29, 2002

(30) Foreign Application Priority Data
Sep. 3, 2001 (JP) 2001-266369
Jun. 28, 2002 (JP) 2002-190693

(51) Int. Cl. B24B 5/00; B23F 21/03

(52) U.S. Cl. 451/544; 451/541

(57) ABSTRACT

A super-abrasive grinding wheel having a core member formed of an aluminum alloy including at least 40% by weight of aluminum, and at least one abrasive layer consisting of super-abrasive grains bonded to at least one surface of the core member, the super-abrasive grinding wheel being operable to perform a grinding operation at a peripheral speed of at least 80 m/s, wherein the core member is at least partially coated with a corrosion-resistant and wear-resistant protective film such as an anodized aluminum film, or a metal film formed by spraying a metallic material in a substantially molten state.

### BACKGROUND OF THE INVENTION

1. Field of the Invention

The present invention relates to improvements in a super-abrasive grinding wheel which has a core member formed of an aluminum alloy including at least 40% by weight of aluminum, and which is used to perform a super-high-speed grinding operation at a peripheral speed of at least 80 m/s.

2. Discussion of Related Art

To perform highly efficient grinding operations or rough-grinding operations, there have been widely used super-abrasive grinding wheels which use super-abrasives such as CBN abrasives or diamond abrasives bonded on a surface of a core member. Recently, there have been developed such super-abrasive grinding wheels wherein the core member is formed of an aluminum alloy. JP-A-2000-141231 discloses an example of such a super-abrasive grinding wheel wherein the core member is formed of a rapidly solidified aluminum alloy. The super-abrasive grinding wheels using such an aluminum alloy core member have weights considerably smaller than those of super-abrasive grinding wheels wherein the core member is formed of any other material such as a steel material.

In a grinding operation using such a super-abrasive grinding wheel a grinding liquid is used. A weak-alkali liquid is widely used as the grinding liquid, for the purpose of preventing proliferation of bacteria within the grinding liquid, and in view of a possibility of contact of an operator's skin with the grinding liquid. In this respect, it is noted that aluminum chemically reacts with a weak-alkali aqueous solution, so that the use of the weak-alkali grinding liquid has a risk of corrosion of the core member formed of an aluminum alloy, in the grinding operation with the super-abrasive grinding wheel having the aluminum alloy core member. However, the corrosion of the core member due to the chemical reaction of the weak-alkali grinding liquid does not lead to a significant problem in a normal grinding operation at a peripheral speed of about 30 m/s, for example, owing to an oxide film formed on the aluminum surface by natural oxidation within the air, and because of a low concentration of hydroxides in the weak-alkali aqueous solution used as the grinding liquid.

The present inventors conducted repetitive tests of grinding operations with super-abrasive grinding wheels using an aluminum alloy for their core members, and found that the core members of the super-abrasive grinding wheels suffered from about 0.01 mm of corrosion after a continuous 24-hour grinding operation, for example, at a considerably high grinding speed, for instance, at a peripheral speed of 80 m/s or higher.

An increase in the amount of corrosion of the core member results in a decrease in the thickness of the core member and a decrease in the area of the outer circumferential surface of the core member to which an abrasive layer is bonded, leading to a possibility of reduction of operating safety of the super-abrasive grinding wheel. On the other hand, a representative example of the aluminum alloy used for the core member is a so-called “high-silicon aluminum alloy” which has a relatively high content of Si, for instance, 15-40% by weight. Although this aluminum alloy has an advantage of lightweight, as indicated above, it is more expensive than the other materials such as steel. To reduce the cost of manufacture of the super-abrasive grinding wheel, in view of the above fact, it has been proposed to re-use or recycle the core member of the super-abrasive grinding wheel when the service life of its abrasive layer has been reached after repeated use of the grinding wheel for the grinding operations. However, a considerable amount of corrosion of the aluminum alloy due to its chemical reaction with the grinding liquid prevents recycling of the core member, resulting in a problem of an increase in the cost of manufacture of the super-abrasive grinding wheel.

The present inventors made a continued research in an effort to find out a cause for an increase in the amount of corrosion of the aluminum alloy of the core member due to its chemical reaction with the weak-alkali grinding liquid. The research revealed a phenomenon that the above-indicated oxide film formed on the surface of the core member by natural oxidation is mechanically removed due to solid substances or bubbles contained in small amounts in the grinding liquid, during a high speed grinding operation with the super-abrasive grinding wheel at a peripheral speed of at least 80 m/s, so that the amount of corrosion of the core member due to the chemical reaction of aluminum with the grinding liquid is gradually increased.

### SUMMARY OF THE INVENTION

The present invention was made in the light of the background art discussed above. It is therefore an object of the present invention to provide a super-abrasive grinding wheel which includes a core member formed of an aluminum alloy including at least 40% by weight of aluminum and is capable of performing a super-high grinding operation at a peripheral speed of at least 80 m/s, and which is free from a considerable increase in the amount of corrosion of the core member even where the grinding wheel is operated with the use of a weak-alkali grinding liquid.

The object indicated above may be achieved according to the principle of the present invention, which provides a super-abrasive grinding wheel having a core member formed of an aluminum alloy including at least 40% by weight of aluminum, and at least one abrasive layer consisting of super-abrasive grains bonded to at least one surface of the core member, the super-abrasive grinding wheel being operable to perform a grinding operation at a peripheral speed of at least 80 m/s, wherein the core member is at least partially coated with a corrosion-resistant and wear-resistant protective film.

In the super-abrasive grinding wheel of the present invention constructed as described above, the core member formed of an aluminum alloy is at least partially coated with a corrosion-resistant and wear-resistant protective film, which is not mechanically removed due to solid substances or bubbles contained in small amounts in a grinding liquid even when the grinding wheel is operated at a peripheral speed of as high as at least 80 m/s. The protective film prevents significant corrosion of the core member due to its exposure to a weak-alkali grinding liquid used in the grinding operation. Accordingly, the protective film is effective to improve operating safety of the super-abrasive grinding wheel, and permits recycling of the core member, without significant corrosion after repetitive use of the core member, making it possible to reduce the cost of manufacture of the super-abrasive grinding wheel.

In a first preferred form of the super-abrasive grinding wheel of the present invention, the core member is an annular core member having an outer circumferential surface, an inner circumferential surface defining a mounting bore for mounting the grinding wheel on a grinding machine, and opposite annular surfaces, and the protective film is formed on at least the opposite annular surfaces of the annular core member which are to be exposed to a grinding liquid during the grinding operation.

In one advantageous arrangement of the above-described first preferred form of the grinding wheel, the protective film is formed on the outer and inner circumferential surfaces of the annular core member as well as the opposite annular surfaces.

In a second preferred form of the super-abrasive grinding wheel of the invention, the protective film is corrosion-resistant with respect to at least a weak-alkali aqueous solution of pH7.0-11.0. In this preferred form, the protective film has a corrosion resistance high enough to protect the core member against a grinding liquid which is suitably used in a super-high-speed grinding operation with the present grinding wheel.

In a third preferred form of the super-abrasive grinding wheel of the invention, the protective film has a Vickers hardness of at least HV300. This protective film is effectively prevented from being mechanically removed due to the solid substances or bubbles more or less contained in the grinding liquid, even during a super-high-speed grinding operation at a peripheral speed of 80 m/s or higher. Accordingly, the protective film prevents a chemical reaction of the aluminum component of the core member with the grinding liquid, which would cause corrosion of the core member.

In a fourth preferred form of the super-abrasive grinding wheel of the invention, the protective film is an anodized aluminum film formed by subjecting the core member to an anodizing treatment. The anodizing treatment may be effected by using an oxalic acid solution as an electrolyte in which the core member is immersed as an anode, so that the aluminum is oxidized into a porous anodic oxide film, which may be then subjected to a pore-filling operation. Thus, the anodized aluminum film can be relatively easily formed, and the formed anodized aluminum film has a dense structure having high degrees of corrosion and wear resistances.

In a fifth preferred form of the super-abrasive grinding wheel of this invention, the protective film is a metal film formed by spraying a metallic material in a substantially molten state. This metal film has high degrees of corrosion and wear resistances, and is effective to prevent corrosion of the core member even during a super-high-speed grinding operation with the present grinding wheel. In one advantageous arrangement of this preferred form of the invention, the protective film is a metal film formed by plasma spraying of a suitable metallic material such as stainless steel SUSS420, tungsten carbide and a nickel-chromium alloy.

In a sixth preferred form of the super-abrasive grinding wheel of the invention, the aluminum alloy of the core member consists of 15-40% by weight of Si, 0.5-6% by weight of Cu, 0.2-3% by weight of Mg, and a balance essentially consisting of aluminum and inevitably included impurities.

### BRIEF DESCRIPTION OF THE DRAWINGS

The above and other objects, features, advantages and technical and industrial significance of the present invention will be better understood by reading the following detailed description of preferred embodiments of the invention, when considered in connection with the accompanying drawings, in which:

FIG. 1 is a perspective view showing a super-abrasive grinding wheel constructed according to this invention;

FIG. 2 is a fragmentary elevational view of a known super-abrasive grinding wheel in cross section taken in a plane including its axis of rotation;

FIG. 3 is a fragmentary elevational view of the super-abrasive grinding wheel of FIG. 1 in cross section taken in a plane including its axis of rotation;

FIG. 4 is a flow chart illustrating a process of subjecting an annular core member of the grinding wheel of FIG. 1 to an anodizing treatment to form anodized aluminum films on its surfaces, according to one embodiment of this invention;

FIG. 5 is a flow chart illustrating a process of subjecting the annular core member of the grinding wheel of FIG. 1 to a molten-metal spraying step to form metal films on its surfaces, according to another embodiment of this invention; and

FIG. 6 is a fragmentary elevational view of a super-abrasive grinding wheel according to a further embodiment of this invention, in cross section taken in a plane including its axis of rotation.

### DETAILED DESCRIPTION OF THE PREFERRED EMBODIMENTS

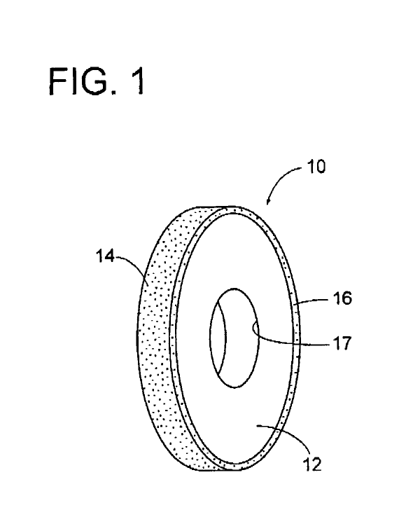

Referring first to the perspective view of FIG. 1, there is shown a super-abrasive grinding wheel 10 constructed according to one embodiment of the present invention. A shown in FIG. 1, the super-abrasive grinding wheel 10 of the present invention takes the form of an annular disc with a center bore, having, for example, an outside diameter of 380 mm, an inside diameter of 80 mm and a thickness of 10 mm. Described more specifically, the super-abrasive grinding wheel 10 consists of an annular core member 12 having a central mounting bore 17 at which the grinding wheel 10 is mounted on a grinding machine, and an abrasive layer 16 bonded to the outer circumferential surface of the annular core member 12. The abrasive layer 16 consists of super-abrasive grains 14 such as diamond or CBN abrasive grains which are held together and bonded to the core member 12 with a resinoid bond or any other bonding agent.

For example, the core member 12 is formed of a rapidly solidified aluminum alloy which consists of 15-40% by weight of Si, 0.5-6% by weight of Cu, 0.2-3% by weight of Mg, and the balance essentially consisting of aluminum and inevitably included impurities, for instance. The aluminum alloy having such a composition has a mechanical strength high enough to withstand a super-high-speed grinding operation at a peripheral speed of at least 80 m/s, for example, and a smaller weight than steel and other metallic materials, so that this aluminum alloy can be suitably used for the core member 12 of the super-abrasive grinding wheel 10 capable of performing a grinding operation at an extremely high speed.

The super-abrasive grinding wheel 10 is mounted at its central core 17 on a main spindle of the grinding machine (not shown), and is rotated about an axis C of rotation thereof such that the abrasive layer 16 is held in pressing contact with a surface of a workpiece held by a suitable clamping device (not shown) while a suitable grinding liquid is delivered between the abrasive layer 16 and the workpiece. Thus, the surface of the workpiece is ground by the abrasive layer 16, to a desired shape.

In a grinding operation using this super-abrasive grinding wheel 10, a weak-alkali liquid is often used as the grinding liquid, for the purpose of preventing proliferation of bacteria within the grinding liquid, and in view of a possibility of contact of an operator's skin with the grinding liquid. In this respect, it is noted that aluminum chemically reacts with a weak-alkali aqueous solution, as indicated by the following chemical reaction formula, and is dissolved in the weak-alkali aqueous solution:

2Al+2OH⁻+6H₂O 2Al (OH)4⁻+3H₂

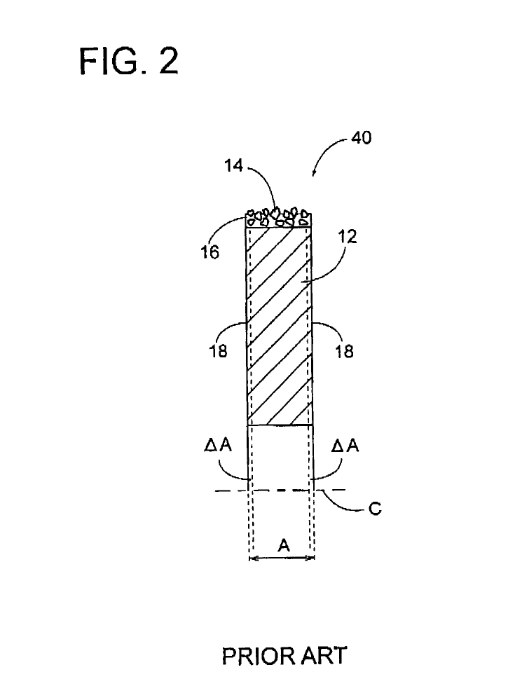

When a weak-alkali grinding liquid is used in a grinding operation with the super-abrasive grinding wheel 10 wherein the core member 12 is formed of an aluminum alloy, the core member 12 is slowly dissolved in the grinding liquid due to the above-indicated chemical reaction, namely, the core member 12 suffers from corrosion in the presence of the grinding liquid. Actually, however, the corrosion of the core member 12 due to the chemical reaction of the weak-alkali grinding liquid does not lead to a significant problem, owing to an oxide film (passive film) formed on the aluminum surface by natural oxidation within the air, and because of a low concentration of hydroxides in the weak-alkali aqueous solution used as the grinding liquid.

Where the super-abrasive grinding wheel 10 is operated at a peripheral speed as high as at least 80 m/s, however, the core member 12 may be corroded to some extent with the grinding liquid. Referring to the elevational view of FIG. 2 showing a known super-abrasive wheel 40 in cross section taken in a plane including its rotation axis C, the super-abrasive wheel 40 which has a nominal thickness A prior to its initial use is gradually corroded on the opposite annular surfaces 18 of the annular core member 12 during its use for a long time, so that the thickness is reduced to (A−2ΔA), where “ΔA” represents a depth of corrosion on each annular surface 18. While this corrosion. depth ΔA is as small as about 0.01 mm during a continuous 24-hour grinding operation, a total corrosion depth during a continuous one-month grinding operation amounts to as large as about 0.6 mm, which is not negligible. Although the corrosion does not take place in a grinding operation at an ordinary speed, as described before, the corrosion takes place to a significant extent in a super-high-speed grinding operation at a peripheral speed of as high as at least 80 m/s, presumably because the oxide film formed on the surface of the core member 12 by natural oxidation is mechanically removed due to solid substances or bubbles contained in small amounts in the grinding liquid, so that the chemical reaction takes place between aluminum of the core member 12 and the grinding liquid, resulting in a progress of the corrosion of the core member 12.

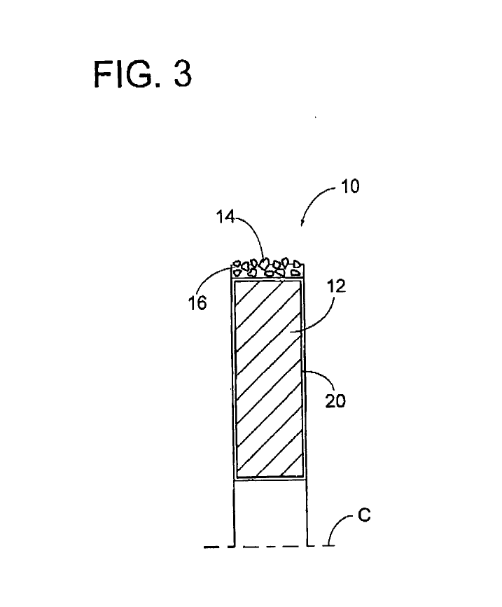

Referring next to the elevational view of FIG. 3 showing the super-abrasive grinding wheel 10 of the present invention in cross section taken in a plane including its rotation axis C, all surfaces of the core member 12 are coated with corrosion-resistant and wear-resistant protective films 20, which are formed before the super-abrasive grains 14 are bonded to the circumferential surface of the core member 12. Preferably, these protective films 20 are constituted by anodized aluminum films (alumite films) formed by subjecting the core member 12 to an anodizing treatment (anodization or anodic oxidation treatment), or metal films formed by subjecting the core member 12 to a molten-metal spraying operation, as described below in detail.

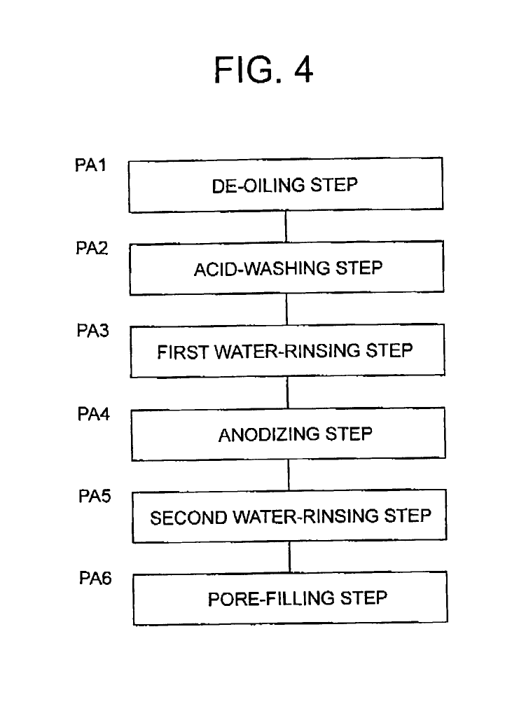

For example, the anodized aluminum films 20 may be formed on the surfaces of the annular core member 12, by subjecting the core member 12 to an anodizing treatment as illustrated in the flow chart of FIG. 4, according to a first embodiment of the present invention. As shown in the figure, a de-oiling or de-greasing step PA1 is initially implemented to remove oily substances or any other foreign matters from the core member 12. The de-oiling step PA1 is followed by an acid-washing step PA2 wherein the oxide films formed on the surfaces of the core member 12 by natural oxidation as described above are removed by application of an acidic agent, to exposed bright surfaces of the core member 12. Successively, a first water-rinsing step PA3 is implemented to remove the acidic agent remaining on the surfaces of the core member 12. The first water-rinsing step PA3 is followed by an anodizing step PA4 in which the core member 12 is immersed in a mass of an electrolyte such as an oxalic acid solution, and an electric current is applied to the core member 12 as the anode, so that the anodic oxide films are formed on the surfaces of the core member 12. Each of the thus formed anodic oxide films consists of amorphous or crystalline alumina (Al₂O₃). In the anodic oxidation using the electrolyte in the form of an oxalic acid solution, each anodic oxide film has several tens to several hundreds of pores per 1 μm₂, each having a diameter of up to several tens of nanometers, such that the pores are formed perpendicularly to the surface of the film. In the present embodiment, the anodizing step PA4 is followed by a second water-rinsing step PA5 to remove the oxalic acid remaining on the surfaces of the anodic oxide films, and a pore-filling step PA6 in which the core member 12 is held in a pressurized vapor for a suitable length of time. As a result, the above-indicated anodic oxide films are changed into boehmite (Al₂O₃.H₂O). In the manner described above, the surfaces of the core member 12 are coated with the corrosion- and wear-resistant, anodized aluminum films which have a high degree of corrosion resistance with respect to an alkali aqueous solution of pH7.0-11.0, and a Vickers hardness of at least HV300.

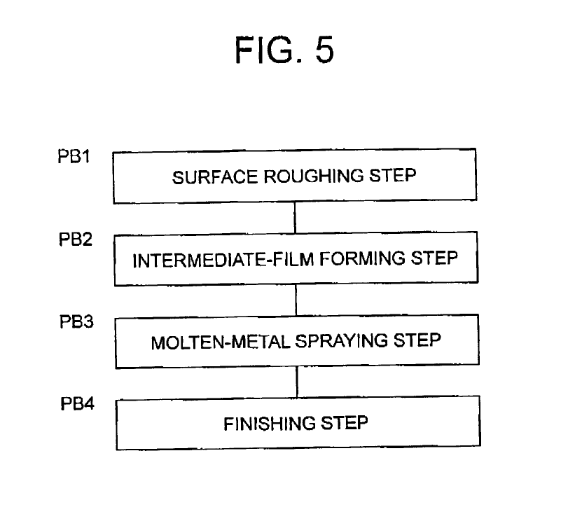

Referring to the flow chart of FIG. 5, there is illustrated a process of subjecting the core member 12 to a molten-metal spraying operation to form the metal films 20 on the surfaces of the core member 12, according to a second embodiment of this invention. As shown in this figure, a surface roughing step PB1 is initially implemented to roughen the surfaces of the core member 12 by shot blasting, for example. In the next intermediate-film forming step PB2, intermediate films are formed on the surfaces of the core member 12, by spraying a suitable metallic material in a molten or semi-molten state, for example, so that the intermediate films improve the adhesion of the metal films 20 to be formed in the next molten-metal spraying step PB3 as described below. For instance, a nickel-aluminum alloy is preferably used as the material of the intermediate films. In the molten-metal spraying step PB3, a suitable metallic composition, such as stainless steel SUS420, tungsten carbide or a nickel-chromium alloy, for example, is sprayed in a molten or semi-molten state on the intermediate films already formed on the surfaces of the core member 12. A suitable spraying device such as a gas-type spraying device or an electric spraying device is selectively used depending upon the melting point of the specific metal composition to be sprayed. With the selected spraying device, the selected metal composition is heated to a molten or semi-molten state and sprayed onto the intermediate films, to form the metal films 20 on the intermediate films. Where a metal composition such as tungsten carbide having a relatively high melting point is used, the metal composition can be melted into a molten state, by plasma spraying in an inert-gas atmosphere such as argon gas. The metal composition may take the form of a wire or a powder. For instance, a powder of tungsten-carbide having a average particle size of about 50 μm is melted in an inert-gas atmosphere and plasma-sprayed at a pressure of 0.5 MPa, to form the metal films 20 having a thickness of about 0.15 mm. Alternatively, a wire of SUS 420 having a diameter of about 1.0 mm is melted in the atmosphere and arc-sprayed at a pressure of 0.5 MPa, to form the metal films 20 having a thickness of about 0.15 mm.

Preferably, the metal composition for the metal films 20 has a Vickers hardness of at least HV300. The core member 12 is further subjected to a finishing step PB4, in which the metal member 12 are machined so as to improve the smoothness of its surfaces, adjust the dimensions and the thickness of the metal films 20. In the manner described above, the surfaces of the core member 12 are coated with the corrosion-resistant and wear-resistant metal films which have a high degree of corrosion resistance to an alkali aqueous solution of pH7.0-11.0, and a Vickers hardness of at least HV300. For instance, the metal films formed of SUS420 and having a thickness of about 0.15 mm has a Vickers hardness of about HV350, while the metal films formed of tungsten carbide and having the same thickness has a Vickers hardness of as high as about HV700.

The present inventors conducted a test on specimens 1 and 2 of the super-abrasive grinding wheel according to the present invention, and a comparative specimen. Namely, the comparative specimen 1 used in the test is a super-abrasive grinding wheel of the invention wherein the anodized aluminum films 20 were formed by the anodizing treatment in the manner illustrated in the flow chart of FIG. 4, on the surfaces of the core member 12 formed of an aluminum alloy which contains 40% by weight of aluminum. The specific 2 is a super-abrasive grinding wheel of the invention wherein the metal films 20 were formed by the molten-metal spraying operation in the manner illustrated in the flow chart of FIG. 5, on the surfaces of the same core member 12. The comparative specimen is a prior art super-abrasive grinding wheel which is identical with the specimens 1 and 2 except in that no protective films 20 were formed on the surfaces of the core member 12. Each of the grinding wheels of the specimens were mounted on a grinding machine, and was operated to perform a continuous grinding operation for 24 hours, at a peripheral speed of 200 m/s, using a grinding liquid of pH10.1. The core members 12 of the specimens were inspected for reduction of their thickness values after the grinding operations. The inspection revealed substantially no reduction of the thickness values of the core members 12 of the specimens 1 and 2 according to the present invention, but revealed corrosion by 0.012 mm of each of the opposite annular surfaces of the core member 12 of the comparative specimen, namely, a total of 0.024 mm reduction of the thickness value of the core member 12 of the comparative specimen. Thus, the present test confirmed that the super-abrasive grinding wheel 10 of the illustrated embodiments has a high degree of corrosion resistance with respect to an alkali aqueous solution, during a super-high-speed grinding operation at a peripheral speed of at least 80 m/s.

As described above, the aluminum alloy core member 12 of the super-abrasive grinding wheel 10 of the illustrated embodiments is coated with the corrosion-resistant and wear-resistant protective films 20, which is not mechanically removed due to solid substances or bubbles contained in small amounts in the grinding liquid, even when the grinding operation is performed at a peripheral speed of 80 m/s or higher. Accordingly, the core member 12 is not corroded even where a weak-alkali grinding liquid is used in the grinding operation, so that the super-abrasive grinding wheel 10 has improved operating safety, and permits recycling of the core member 12 even after its repeated use and significant reduction of the cont of manufacture of the super-abrasive grinding wheel 10.

Further, the protective films 20 exhibiting a high degree of corrosion resistance with respect to at least an alkali aqueous solution within a range of pH7.0-11.0 permits the super-abrasive grinding wheel 10 to be operated at a considerably high peripheral speed, with a sufficient corrosion resistance of its core member 12 with respect to a grinding liquid suitable for use in such a super-high-speed grinding operation.

Further, the protective films 20 having a Vickers hardness of as high as at least HV300 and formed are not mechanically removed from the surfaces of the core member 12, due to the solid substances or bubbles contained in small amounts in the grinding liquid, even during a super-high-speed grinding operation at a peripheral speed of 80 m/s or higher, so that the core member 12 is protected from corrosion due to the chemical reaction of the aluminum component of the core member 12 with the grinding liquid.

The protective films 20 in the form of the anodized aluminum films can be easily formed by subjecting the core member 12 to the anodizing treatment as illustrated in FIG. 4 according to the first embodiment, and have high degrees of corrosion and resistances. The anodized aluminum films are effective to prevent corrosion of the core member 12 of the super-abrasive grinding wheel 10 during a super-high-speed grinding operation.

The protective films 20 in the form of the metal films formed by subjecting the core member 12 to the molten-metal spraying operation as illustrated in FIG. 5 according to the second embodiment also have high degrees of corrosion and wear resistances. The metal films are effective to prevent corrosion of the core member 12 of the super-abrasive grinding wheel 10 during a super-high-speed grinding operation.

While the super-abrasive grinding wheel 10 constructed according to the preferred embodiments of this invention has been described in detail by reference to the drawings, it is to be understood that the invention may be otherwise embodied.

In the super-abrasive grinding wheel 10 of the illustrated embodiments, the resinoid bond (synthetic resin bond) is used to hold together the super-abrasive grains 14 so as to form the abrasive layer 16 and to bond the abrasive layer 16 to the outer circumferential surface of the annular core member 12. However, the principle of this invention is equally applicable to any other types of super-abrasive grinding wheels, such as a segment-type super-abrasive grinding wheel wherein a plurality of abrasive segments each consisting of the super abrasive grains 14 held together with a vitrified bond or a metal bond are bonded to the outer circumferential surface of the core member 12 with a suitable adhesive or bonding agent, and a super-abrasive grinding wheel wherein the super-abrasive grains 14 are directly fixed on the outer circumferential surface of the core member 12, by electrochemical deposition, for example, so as to form the abrasive layer 16.

In the super-abrasive grinding wheel 10 of the illustrated embodiments described above, the cylindrical abrasive layer 16 is formed of the super-abrasive grains 14 bonded to the outer circumferential surface of the annular core member 12. However, the principle of this invention is applicable to a super-abrasive grinding wheel wherein a flat abrasive layer is formed on at least one of the opposite annular surfaces of the annular core member 12, and also applicable to a formed super-abrasive grinding wheel wherein abrasive layers are formed on the core member, so as to form the ground surface of the workpiece to a desired shape.

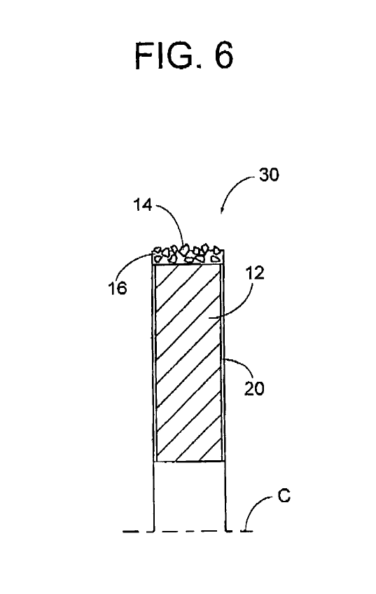

In the super-abrasive grinding wheel 10 of the illustrated embodiments, the protective films 20 are formed on all surfaces of the annular core member 12, that is, on the outer and inner circumferential surfaces and the opposite annular surfaces of the core member 12, as shown in FIG. 3. However, the protective films 20 need not be formed on all surfaces of the core member 12, provided the protective films 20 cover all surface portions of the core member 12 which are exposed to a grinding liquid during a grinding operation with the grinding wheel 10. For instance, the protective films 20 may be formed on only the opposite annular surfaces of the core member 12, as shown in FIG. 6.

The core member 12 used in the illustrated embodiments is formed of a rapidly solidified aluminum alloy whose major components are Al and Si, more specifically, an aluminum alloy consisting of 15-40% by weight of Si, 0.5-6% by weight of Cu, 0.2-3% by weight of Mg, and the balance essentially consisting of aluminum and inevitably included impurities. It is noted, however, that the composition of the core member 12 is by no means limited to that of the illustrated embodiments, and that the present invention is equally applicable to a super-abrasive grinding wheel having a core member formed of an aluminum alloy including at least 40% by weight of aluminum, and at least one abrasive layer consisting of the super-abrasive grains 14.

In the illustrated first embodiment of FIG. 4, the anodic oxide films formed on the surfaces of the core member 12 by the anodizing treatment are subjected to the pore-filling treatment in the pore-filling step PA6, so that the anodic oxide films are changed into boehmite, to thereby form the anodized aluminum films. However, the pore-filling treatment is not essential, as long as the formed protective films 20 have corrosion and wear resistances sufficient to prevent significant corrosion of the core member 12.

Although the protective films 20 provided in the illustrated embodiments are either the anodized aluminum films or the metal films formed by plasma spraying, the protective films are not limited to those films, provided that the protective films have corrosion and wear resistances sufficient to prevent significant corrosion of the core member 12 due to exposure to a grinding liquid during a super-high-speed grinding operation at a peripheral speed of at least 80 m/s. For instance, the protective films may be metal plating films such as Cr or Ni plating films.

It is to be understood that the present invention may be embodied with various other changes, modifications and improvements which may occur to those skilled in the art, without departing from the spirit and scope of the present invention defined in the appended claims.

What is claimed is:

1. A super-abrasive grinding wheel having a core member formed of an aluminum alloy including at least 40% by weight of aluminum, and at least one abrasive layer consisting of super-abrasive grains bonded to at least one surface of said core member, said super-abrasive grinding wheel being operable to perform a grinding operation at a peripheral speed of at least 80 m/s, wherein an improvement comprises:
said core member being at least partially coated with a corrosion-resistant and wear-resistant protective film.

2. A super-abrasive grinding wheel according to claim 1, wherein said core member is an annular core member having an outer circumferential surface, an inner circumferential surface defining a mounting bore for mounting the grinding wheel on a grinding machine, and opposite annular surfaces, said protective film being formed on at least said opposite annular surfaces of said annular core member which are to be exposed to a grinding liquid during said grinding operation.

3. A super-abrasive grinding wheel according to claim 2, wherein said protective film is formed on said outer and inner circumferential surfaces of said annular core member as well as said opposite annular surfaces.

4. A super-abrasive grinding wheel according to claim 1, wherein said protective film is corrosion-resistant with respect to at least a weak-alkali aqueous solution of pH7.0-11.0.

5. A super-abrasive grinding wheel according to claim 1, wherein said protective film has a Vickers hardness of at least HV300.

6. A super-abrasive grinding wheel according to claim 1, wherein said protective film is an anodized aluminum film formed by subjecting said core member to an anodizing treatment.

7. A super-abrasive grinding wheel according to claim 6, wherein said anodizing treatment is effected by using an oxalic acid solution as an electrolyte in which said core member is immersed as an anode.

8. A super-abrasive grinding wheel according to claim 1, wherein said protective film is a metal film formed by spraying a metallic material in a substantially molten state.

9. A super-abrasive grinding wheel according to claim 8, wherein said protective film is a metal film formed by plasma-spraying of said metallic material.

10. A super-abrasive grinding wheel according to claim 1, wherein said aluminum alloy consists of 15-40% by weight of Si, 0.5-6% by weight of Cu, 0.2-3% by weight of Mg, and a balance essentially consisting of aluminum and inevitably included impurities.
